(19) United States
(12) Patent Application Publication
(10) Pub. No.: US 2008/0074611 A1
(43) Pub. Date: Mar. 27, 2008

(54) Hybrid contact lens with improved resistance to flexure and method for designing the same

(76) Inventors: William E. Meyers, Scottsdale, AZ (US); Jerome Legerton, San Diego, CA (US); Hermann H. Neidlinger, San Jose, CA (US); Ramezan Benrashid, Concord, NC (US); Diethard Merz, San Diego, CA (US); Robert Joyce, San Clemente, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/525,535

(22) Filed: Sep. 22, 2006

(51) Int. Cl. G02C 7/04

(52) U.S. Cl. 351/160 R

(57) ABSTRACT

A hybrid contact lens includes a substantially rigid center portion having a flexural deformation of about 10% at an applied load of at least about 50 grams and a Dk of at least about 30×10⁻¹¹ (cm²/sec) (mL O₂)/(mL mm Hg). The hybrid contact lens also includes a substantially flexible skirt portion connected to the center portion. A method of designing a hybrid contact lens includes determining the applied load that results in a selected flexural deformation.

### BACKGROUND OF THE INVENTION

1. Field of the Invention

The present invention relates in certain embodiments to hybrid contact lenses. More particularly, embodiments of the invention relate to hybrid contact lenses having improved resistance to flexure.

2. Description of the Related Art

Traditionally, the field of vision correction involved measuring aberrations in the optics of the eye, creating a prescription that corrected for the measured aberrations, then using the prescription to correct the measured aberration, e.g., by surgery, spectacles or contact lenses. Thus, the ability to correct vision aberrations was limited by both the degree of accuracy in the measurement of the aberrations and by the ability to correct the measured aberration.

The field of vision correction is currently in the midst of a revolution. New technologies that have been developed to measure a variety of aberrations in the optics of the eye to a high degree of accuracy. These new wavefront measurement techniques (such as Shack-Hartmann wavefront sensing or Talbot Interferometry) can precisely measure the eye's aberrations to such a high degree of accuracy that, at least in theory, a customized prescription could be created to correct vision so that it is better than 20/20. Recent advances in laser refractive surgery techniques, such as LASIK and photorefractive keratectomy, as well as improvements in spectacle lens manufacturing now enable vision to be corrected using eye surgery or spectacles to a degree of accuracy that approaches the accuracy of the new measurement technologies.

However, this is generally not the case with contact lenses, particularly when the correction of higher order aberrations is desired. Popular soft contact lenses cannot currently achieve the same degree of corrective accuracy as spectacles or laser refractive surgery because of dimensional variations in the lenses resulting from conventional soft contact lens fabrication processes. Hard contact lenses, which could theoretically provide the platform to achieve the highly accurate corrections achievable by surgery and spectacles, are not as comfortable as soft contacts and generally lack positional stability on the eye.

Hybrid hard-soft contact lenses, having a relatively hard center portion and a relatively soft outer skirt, have been developed which could theoretically provide a platform for a more accurate corrective prescription and also provide the comfort of soft contact lenses. However, a significant clinical problem with hybrid contact lenses is flexure of the lens during wear, a problem that is often referred to as on-eye flexure. On-eye flexure of a lens can induce undesired optical aberrations, such as astigmatic error, which lead to a degree of vision correction by the prescribed lens that is not as accurate as the accuracy of the new measurement technologies.

Accordingly, there is a need for an improved contact lens, such as a hybrid contact lens, with improved resistance to flexure. However, increasing resistance to flexure is not a simple matter of increasing the thickness of the relatively hard center portion or using stiffer materials to make the relatively hard center portion, because in the past those approaches have been found to result in hybrid lenses having undesirably low oxygen transmission. Previously commercialized hybrid contact lenses having a rigid center and a soft peripheral skirt, such as the Saturn™ and SoftPerm™ lenses by Ciba Vision of Duluth, Ga., have experienced flexure problems, along with relatively low oxygen transmission, fragile junctions between the rigid center and the soft peripheral skirt, and relatively high manufacturing costs.

### SUMMARY OF THE INVENTION

In one aspect, embodiments of the present invention provide hybrid contact lenses that exhibit a relatively low degree of flexure. In preferred embodiments, the newly developed hybrid lenses exhibit relatively high oxygen transmission, e.g., a Dk of at least about 30 barrer, preferably at least about 100 barrer, thus providing increased comfort to the patient. The combination of a relatively low degree of flexure and relatively high oxygen transmission enables the manufacture of contact lenses that are capable of providing both comfort and a degree of vision correction that approaches the accuracy of the new measurement technologies.

In an embodiment a hybrid contact lens is provided, comprising a substantially rigid center portion having a flexural deformation of about 10% at an applied load of at least about 50 grams and having a Dk of at least about 30 barrer. The hybrid contact lens also comprises a substantially flexible skirt portion connected to the center portion.

In another embodiment, a method of designing a hybrid contact lens having a substantially rigid center portion and a substantially flexible skirt portion is provided. The method comprises providing an equation relating a plurality of design parameters for the rigid center portion. The plurality of design parameters comprise at least a diameter parameter, an edge thickness parameter, a center thickness parameter, and an applied load parameter. The method also comprises selecting a target applied load value for the rigid center portion. The method further comprises entering the target applied load value into the equation and determining a diameter value, an edge thickness value, and a center thickness value that satisfy the equation. The method additionally comprises manufacturing a sample rigid center portion having dimensions that correspond to the diameter value, the edge thickness value and the center thickness value, determining an applied load value for the sample rigid center portion, and comparing the determined applied load value to the target applied load value.

These and other embodiments are described in greater detail below.

### BRIEF DESCRIPTION OF THE DRAWINGS

These and other aspects of the embodiments will be readily apparent from the description below and the appended drawings (not to scale), in which like reference numerals refer to similar parts throughout, which are meant to illustrate and not to limit the invention, and in which:

FIG. 1 is a perspective schematic view of an embodiment of a hybrid contact lens described herein;

FIG. 2 is a schematic cross-sectional side view of an embodiment of a hybrid contact lens described herein;

FIG. 3 is a flow chart illustrating an embodiment of a method of designing a hybrid contact lens;

FIG. 4A is a contour plot illustrating predicted values of applied load to achieve a flexural deformation of 10% as a function of center thickness and edge thickness for an embodiment of a center portion for a (−) dioptric power hybrid contact lens;

FIG. 4B is a plot illustrating the correlation between measured and predicted applied loads to achieve a flexural deformation of 10% in the center portion of FIG. 4A.

FIG. 5A is a contour plot illustrating predicted values of applied load to achieve a flexural deformation of 20% as a function of center thickness and edge thickness for an embodiment of a center portion for a (−) dioptric power hybrid contact lens;

FIG. 5B is a plot illustrating the correlation between measured and predicted applied loads to achieve a flexural deformation of 20% in the center portion of FIG. 5A.

FIG. 6A is a contour plot illustrating predicted values of applied load to achieve a flexural deformation of 30% as a function of center thickness and edge thickness for an embodiment of a center portion for a (−) dioptric power hybrid contact lens;

FIG. 6B is a plot illustrating the correlation between measured and predicted applied loads to achieve a flexural deformation of 30% in the center portion of FIG. 6A.

FIG. 7A is a contour plot illustrating predicted values of applied load to achieve a flexural deformation of 10% as a function of center thickness and edge thickness for an embodiment of a center portion for a (+) dioptric power hybrid contact lens;

FIG. 7B is a plot illustrating the correlation between measured and predicted applied loads to achieve a flexural deformation of 10% in the center portion of FIG. 7A.

FIG. 8A is a contour plot illustrating predicted values of applied load to achieve a flexural deformation of 20% as a function of center thickness and edge thickness for an embodiment of a center portion for a (+) dioptric power hybrid contact lens;

FIG. 8B is a plot illustrating the correlation between measured and predicted applied loads to achieve a flexural deformation of 20% in the center portion of FIG. 8A.

FIG. 9A is a contour plot illustrating predicted values of applied load to achieve a flexural deformation of 30% as a function of center thickness and edge thickness for an embodiment of a center portion for a (+) dioptric power hybrid contact lens;

FIG. 9B is a plot illustrating the correlation between measured and predicted applied loads to achieve a flexural deformation of 30% in the center portion of FIG. 9A.

### DETAILED DESCRIPTION OF THE PREFERRED EMBODIMENTS

The term “hybrid contact lens” as used herein has its ordinary meaning as known to those skilled in the art and thus includes a variety of contact lenses adapted for positioning on the surface of the eye, the contact lenses comprising a substantially rigid center portion and a substantially flexible skirt portion connected to the center portion about the periphery of the center portion. In many cases the skirt portion comprises a substantially flexible annular portion coupled to the substantially rigid center portion at a junction defined at least in part by an outer edge of the substantially rigid center portion. Examples of hybrid contact lenses include those described in U.S. Pat. No. 7,018,039 and U.S. Patent Publication No. 2004/0046931 A1, both of which are hereby incorporated by reference in their entireties, and particularly for the purpose of describing hybrid contact lenses and methods of making them.

The term “flexural deformation” as used herein has its ordinary meaning as known to those skilled in the art, see International Standard ISO 11984:1999(E) “Ophthalmic optics—Contact lenses—Determination of rigid lens flexure and breakage.” In the context of the hybrid contact lenses described herein, flexural deformation will be understood as a reference to the reduction of the diameter of the substantially rigid center portion of the hybrid contact lens due to a load applied to an edge of the substantially rigid center portion, perpendicular to the lens axis, to reduce flexure, expressed as a percentage of the original diameter of the substantially rigid center portion. Thus, flexural deformation values described herein may be measured on the relatively rigid center portion of the hybrid lens in accordance with the standard method described in the aforementioned ISO 11984:1999(E). Flexural deformation values described herein may also be measured on relatively rigid center portions in accordance with ISO 11984:1999(E), with the exception that the diameter of the rigid center portions tested may deviate from those recited in ISO 11984:1999(E).

The term “on-eye flexure” refers to bending or other movement of at least a portion of a contact lens when in contact with an eye that causes the contour of the base curve of the optical portion of the lens to change, thereby altering the ability of the contact lens to correct a given aberration.

Flexural deformation may be expressed herein as a certain percentage that is obtained within a given range of applied loads. For example, in various embodiments, hybrid contact lenses are described herein as having a substantially rigid center portion having a flexural deformation of about 10%, 20%, or 30%, at an applied load of at least about 50 grams or in the range of about 50 grams to about 200 grams. It will be understood that such expressions refer to situations in which the recited flexural deformation value is obtained at a particular applied load (or range of loads) that is within the recited range of values, and should not be understood to require that the recited flexural deformation value be obtained at all applied loads that are within the recited range of values.

The term “Dk” as used herein has its ordinary meaning as known to those skilled in the art and thus will be understood as a reference to the oxygen permeability of a contact lens, i.e., the amount of oxygen passing through the contact lens material over a given set of time and pressure difference conditions, expressed in units of 10⁻¹¹ (cm²/sec) (mL O₂)/(mL mm Hg), a unit that is know as a barrer. Those skilled in the art will appreciate that oxygen transmissibility can be expressed as Dk/t, where t is the thickness of the lens, and thus Dk/t represents the amount of oxygen passing through a contact lens of a specified thickness over a given set of time and pressure difference conditions, expressed in units of barrers/cm or 10⁻¹¹ (cm/sec) (mL O₂)/(mL mm Hg). See ISO International Standard 9913-1. Determination of Oxygen Permeability and Transmissibility by the Fatt Method. Geneva, Switzerland: International Organization for Standardization, 1996 and ISO International Standard 9913-1. Optics and optical instruments—Contact lenses. Geneva, Switzerland: International Organization for Standardization, 1996.

Those skilled in the art will understand that references herein to particular monomeric materials to be references to such monomers as well as to both crosslinked and uncrosslinked versions of polymers (including copolymers) formed by polymerizing or copolymerizing the recited monomers, unless clearly stated otherwise.

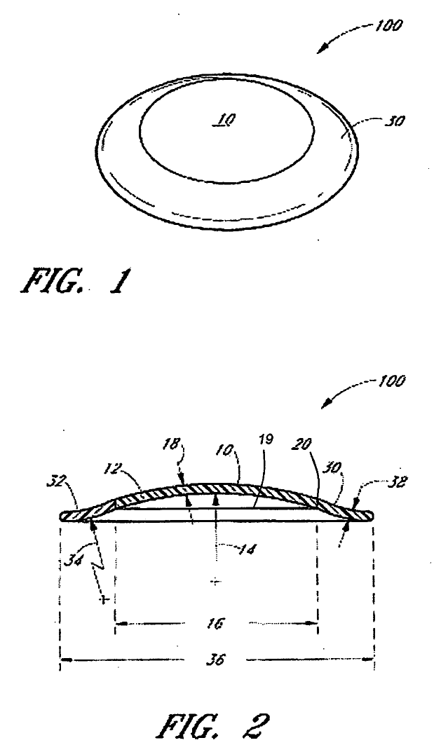

FIGS. 1 and 2 illustrate an embodiment of a hybrid contact lens 100. The hybrid contact lens 100 has a substantially rigid portion 10 and a substantially flexible skirt portion 30 connected to the center portion at a junction 20. The substantially rigid portion 10 typically comprises or consists essentially of a polymer that is configured (e.g., cross-linked) to reduce or inhibit flexure, as further discussed below.

Preferably, the substantially rigid portion 10 is gas permeable and has a first curvature or curved surface 12. In the illustrated embodiment, the substantially rigid portion 10 is the central portion (rigid center) of the hybrid contact lens 100. In an embodiment, the substantially rigid center portion 10 has Dk value of at least about 30 barrers. However, other Dk values are possible in other embodiments. For example, in another embodiment the substantially rigid center portion 10 has a Dk value of at least about 100 barrers. In another embodiment, the substantially rigid center portion 10 has a Dk value of at least about 130 barrers; in another, at least about 150 barrers.

In the illustrated embodiment, the hybrid contact lens 100 has a first curvature 12 or base curve having a contour defined by a radius 14. In an embodiment, the radius 14 has a length in the range of about 5.0 mm to about 10.5 mm, for example about 7.70 mm. However, other suitable values for the radius 14 can be used. The hybrid contact lens 100 also defines a diameter 16 of the substantially rigid center portion 10, as shown in FIG. 2. This diameter 16 may be, in general, approximately greater than, less than, or equal to the chord 19 defined by the intersection points of radius 14 of the base curve 12 with the surface of the lens 100. In an embodiment, the substantially rigid center portion 10 has a diameter 16 in the range of about 4.0 mm to about 12.0 mm, for example about 8.5 mm. However, the diameter 16 can have other suitable values. In the illustrated embodiment, the substantially rigid center portion 10 has a thickness 18 that is generally uniform along the base curve 12. In an embodiment, the thickness 18 is in the range of about 0.06 mm and about 0.40 mm, for example about 0.20 mm. However, other suitable values for the thickness 18 can be used. In other embodiments, the thickness 18 can taper from the apex to the circumferential edge of the substantially rigid portion 10. Reference to the center thickness of the substantially rigid center portion 10 will be understood as a reference to the axial or radial thickness of the center portion 10 along the lens axis at approximately the geometrical center. Reference to the edge thickness of the substantially rigid center portion 10 will be understood as a reference to the peripheral portion of the center portion 10 having a surface continuous with the front and back surfaces of the center portion 10. Those of ordinary skill in the art will recognize that the thickness 18 can have a variety of suitable configurations.

Preferably, the circumferential edge of the substantially rigid center portion 10 is connected at the junction 20 to the substantially flexible skirt portion 30 of the hybrid contact lens 100, as shown in FIG. 2. In the illustrated embodiment, the substantially flexible skirt portion 30 is a substantially flexible annular portion that is coupled to the substantially rigid center portion 10 at the junction 20 defined at least in part by an outer edge of the substantially rigid center portion 10. Methods for forming a connection between a substantially rigid center portion and a substantially flexible skirt portion in a hybrid contact lens can be found in, e.g., U.S. Patent Publication No. 2005/0018130 A1, which is hereby incorporated by reference in its entirety and particularly for the purpose of describing such methods. Other methods may also be used. It will be understood that the junction 20 may define the edge of a transition region (not shown in FIG. 2) in which the materials and properties of the center portion 10 gradually taper or merge into the materials and properties of the skirt portion 30, or in which the skirt portion itself comprises or consists essentially of such a tapered structure. In such cases, it will be understood that the junction 20 defines the edge of such a transition region, which in turn is used to determine the diameter 16 of the substantially rigid center portion 10.

The substantially flexible skirt portion 30 is preferably defined by a second curvature or curved surface 32. In an embodiment, the second curvature 32 is defined by a skirt radius 34 having a length in the range of about 7.0 mm to about 11.0 mm, for example about 9.0 mm. However, the skirt radius 34 can have other suitable values. In the illustrated embodiment, the skirt radius 34 is longer than the center portion radius 14. However, in other embodiments, the skirt radius 34 is about equal to the center portion radius 14. In still another embodiment, the skirt radius 34 is shorter than the center portion radius 14.

The substantially flexible skirt portion 30 has a skirt thickness 38. In a preferred embodiment, the skirt thickness 38 is generally uniform throughout the substantially flexible skirt portion 30. In an embodiment, the thickness 38 is in the range of about 0.04 mm to about 0.28 mm, for example about 0.12 mm. However, in other embodiments, the skirt thickness 38 can have other suitable values and/or vary along the soft skirt 30. In an embodiment, the skirt thickness 38 tapers from the junction 20 to an overall lens diameter 36. In another embodiment, the thickness 38 is sculpted, as discussed in U.S. application Ser. No. 11/123,876, filed May 6, 2005, which is hereby incorporated by reference in its entirety and particularly for the purpose of describing such hybrid lenses and methods of making them. In an embodiment, the overall lens diameter 36 is in the range of about 10.0 mm to about 20.0 mm, for example about 14.5 mm. However, other suitable values for the overall lens diameter 36 can be used. Those skilled in the art will understand that, in the illustrated embodiment, the value of the overall lens diameter 36 is the same as that of the outer diameter of the skirt portion 30.

The substantially rigid center portion 10 and the substantially flexible skirt portion 30 of the hybrid contact lens 100 are preferably manufactured using materials suitable for use in hybrid contact lenses. The hybrid contact lens 100 can be manufactured using any suitable method for making hybrid contact lenses.

The substantially rigid center portion preferably has a relatively high modulus, e.g., an elastic modulus in the range of about 8,500 to 22,000 kgf/cm². The substantially rigid center portion preferably comprises a polymeric material suitable for inclusion in a contact lens. Preferably, the polymeric material is crosslinked to a degree that provides the desired modulus, in a manner known to those skilled in the art. The substantially rigid center portion may comprise, for example, one or more polymeric materials comprising recurring units selected from (meth)acrylic monomers including linear, branched and cyclic alkyl (meth)acrylates, silicone-containing (meth)acrylates, fluorine-containing (meth)acrylates, hydroxyl group containing (meth)acrylates, (meth)acrylic acid, N-(meth)acryloylpyrrolidone, (meth)acrylamides, aminoalkyl (meth)acrylates, alkoxy group-containing (meth)acrylates, aromatic group containing (meth)acrylates, silicone-containing styrene derivatives, fluorine-containing styrene derivatives, styrene derivatives, and vinyl monomers.

The substantially flexible skirt portion 30 preferably has a relatively low modulus, preferably a modulus that is lower than the modulus of the substantially rigid center portion 10, e.g., an elastic modulus in the range of about 1.5 to 30 kfg/cm². In a preferred embodiment, the skirt portion 30 comprises or consists essentially of a hydrophilic annular skirt that extends from the junction 20 at the circumferential edge of the rigid portion 10 to an outer diameter or overall lens diameter 36 of the contact lens 100. In another embodiment, the skirt portion 30 is not hydrophilic.

The skirt portion 30 preferably comprises a polymeric material that comprises recurring units. The skirt portion 30 may comprise a non-cross-linked and/or gas permeable material. The skirt portion 30 can be made in various ways. For example, in an embodiment, the skirt portion is thermally formed. In another embodiment, the skirt portion 30 is cast. In still another embodiment, forming the flexible portion 30 comprises polymerizing the requisite monomers in the presence of the rigid portion 10. In some embodiments, the flexible portion 30 comprises or consists essentially of a hydrogel.

The skirt portion 30 preferably comprises a polymeric material that comprises recurring units selected from (meth)acrylic monomers including linear, branched and cyclic (siloxanyl)alkyl (meth)acrylates, silicone-containing (meth)acrylates, fluorine-containing (meth)acrylates, hydroxyl group containing (meth)acrylates, (meth)acrylic acid, N-(meth)acryloylpyrrolidone, (meth)acrylamides, aminoalkyl (meth)acrylates, alkoxy group-containing (meth)acrylates, aromatic group containing (meth)acrylates, glycidyl (meth)acrylate, tetrahydrofurfuryl (meth)acrylate, silicone-containing styrene derivatives, fluorine-containing styrene derivatives, styrene derivatives, and vinyl monomers.

The substantially rigid center portion 10 and substantially flexible skirt portion 30 may be formed in an integral manner, or may be joined or coupled by a bonding material or resin including any of the following materials, including combinations and derivatives thereof: vinyl acetate; 2-hydroxylethylmethacylate (HEMA), methyl methacrylate, ethyl methacylate, ethylacrylate, methyl acrylate, acrylate and methacrylate oligomers, acidic acrylate and methacrylate oligomers, polyester acrylate, polyester, acrylate phosphate ester, aliphatic urethane acrylate, and epoxy terminated acrylate oligomers containing heat or UV initiators. The junction can also be modified by oxygen or ammonia plasma and corona treatment prior to casting the soft material around the hard center.

Further discussion of materials and methods of manufacture of hybrid contact lenses are provided in U.S. Patent Publication No. 2004/0212779 A1, which is hereby incorporated by reference and particularly for the purpose of describing such materials and methods.

As discussed above, users of prior hybrid contact lenses have experienced on-eye flexure problems. Accordingly, it is advantageous to reduce on-eye flexure. It has now been found that resistance to on-eye flexure (as determined by flexural deformation measurements) tends to be sensitive (to a greater or lesser degree, depending on the design) to the following design parameters for the rigid center portion: a diameter parameter, an edge thickness parameter, a center thickness parameter, and an applied load parameter. Mathematical relationships between these parameters have been identified, and are described further below, that enable a variety of hybrid contact lenses to be designed that have the desired degree of flexural deformation.

For example, an embodiment provides a hybrid contact lens has a substantially rigid center portion having a flexural deformation of about 10% at an applied load of at least about 50 grams and a Dk of at least about 30 barrers. The hybrid contact lens also has a substantially flexible skirt portion connected to the center portion. In an embodiment, the flexural deformation is about 10% at an applied load in the range of about 50 grams to about 200 grams. In still another embodiment, the flexural deformation is about 20% at an applied load of at least about 50 grams. In yet another embodiment, the flexural deformation is about 20% at an applied load in the range of about 50 to about 200 grams. In another embodiment, the flexural deformation is about 30% at an applied load of at least about 50 grams. In another embodiment, the flexural deformation is about 30% at an applied load in the range of about 50 to about 200 grams.

An alternative embodiment provides a hybrid contact lens which has a substantially rigid center portion having a flexural deformation of about 10% at an applied load of at least about 10 grams and having a Dk of at least about 100 barrers; and a substantially flexible skirt portion connected to the center portion. In an embodiment, the flexural deformation is about 10% at an applied load in the range of about 10 grams to about 200 grams. In another embodiment, the flexural deformation is about 20% at an applied load of at least about 10 grams. In another embodiment, the flexural deformation is about 20% at an applied load in the range of about 10 to 200 grams. In another embodiment, the flexural deformation is about 30% at an applied load of at least about 10 grams. In another embodiment, the flexural deformation is about 30% at an applied load in the range of about 10 to 200 grams.

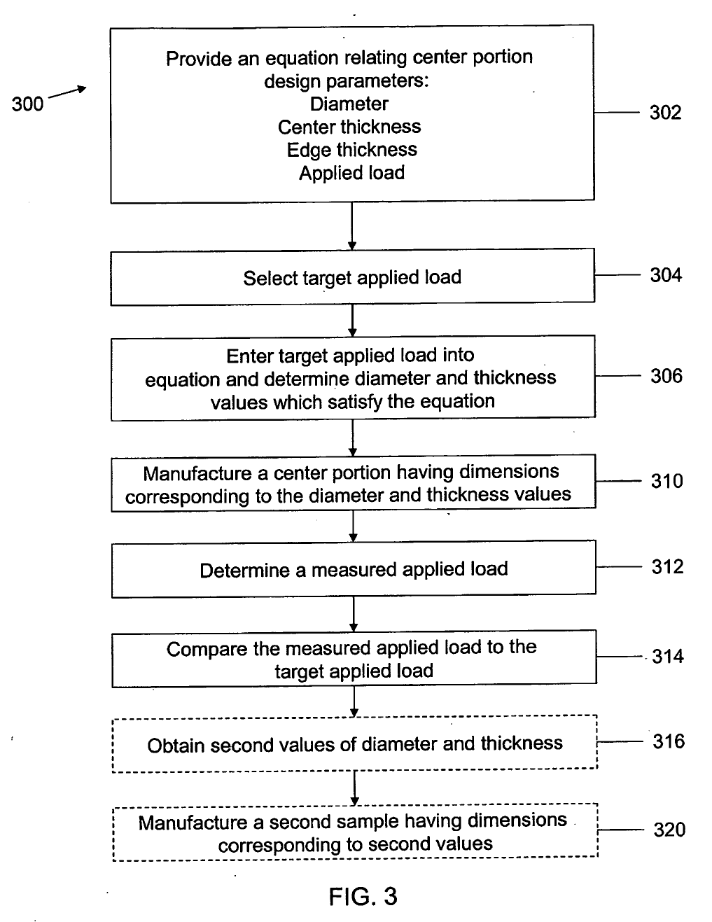

FIG. 3 illustrates a method of designing a hybrid contact lens having a substantially rigid center portion and a substantially flexible skirt portion using a mathematical equation relating design parameters of diameter (D), edge thickness (ET), center thickness (CT), and applied load (F) parameters. In alternative embodiments, other parameters of the lens may be employed, including, for example, the base curve of the rigid portion of the lens. The illustrated method 300 begins at step 302 by providing an equation that relates a plurality of design parameters for the rigid center portion, the plurality of design parameters comprising at least a diameter parameter (D), an edge thickness parameter (ET), a center thickness parameter (CT), and an applied load parameter (F). Equation (1) is an example of such an equation:

F=k₁·ET²−k₂·ET+k₃·D²−k₅D+k₅·CT²+k₆·CT+k₇ (1)

### In Equation (1), k₁, k₂, k₃, k₄, k₄, k₆ and k₇ are empirically determined constants which are typically a function at least of the modulus of the rigid center portion.

In an embodiment, the constants k₁-k₇ are determined by a multi-step empirical fitting process to experimentally measured data. For example, k₁ and k₂ can be determined in a first step, where a second order polynomial is fit to a plot of the experimentally measured applied load as a function of a first design parameter, selected in a manner discussed in greater detail below, for example ET. The applied load is the load that results in a selected level of flexural deformation within the rigid center portion. The second order polynomial in ET is given by Equation (2):

F=k₁·ET²−k₂·ET+k′ (2)

where k′ is also a constant.

The constants k₃ and k₄ can then be obtained in a second curve fitting step. The difference between the predicted force values provided by Equation (2) and the experimentally measured applied load values can be computed in this example to provide a first residual (R₁). The first residual (R₁) can be plotted against a second design parameter, selected in a manner discussed in greater detail below, and fit to a second order polynomial in that design parameter, for example D. Such a second order polynomial in D is given in Equation (3):

R₁=k₃·D²−k₄D+k″ (3)

where k″ is also a constant.

The constants k₅ and k₆ can then be obtained in a third curve fitting step. A second residual (R₂), can be computed as the difference between the experimentally measured applied load and a predicted value given by Equation (4):

F=k₁·ET²−k₂·ET+k₃·D²−k₄·D+k′+k″ (4)

### The second residual (R₂) can be plotted against a third design parameter, such as CT, and fit to a second order polynomial in CT, according to Equation (5):

R₂=k₅·CT²−k₆·CT+k′″ (5)

In this manner, values for k₁-k₆ can be obtained. A value for k₇ is given by the sum: k′+k″+k′″.

Approximate ranges for the values of k₁-k₇ utilized in one embodiment of Equation (1), where the first parameter is ET, the second parameter is D, and the third parameter is CT, are illustrated below in Table 1 for selected levels of flexural deformation in the range of about 10 to 30%.

TABLE 1
Constant value ranges for use with Equation (1)

| Constant | Value |
|---|---|
| k₁ | 600–6400 |
| k₂ | 300–1600 |
| k₃ | 0.8–8 |
| k₄ | 14–120 |
| k₅ | 30–3700 |
| k₆ | 60–600 |
| k₇ | 50–600 |

It will be understood that the form of Equation (1) and the values of k₁-k₇ are examples, and that other equations and corresponding constants may be applicable in any particular design or material system. For example, the values of k₁-k₇ are likely to be different for designs using significantly different materials, e.g., materials with different moduli or Dk. Suitable equations and constants may be determined by routine experimentation by those skilled in the art, in view of the guidance provided herein.

As discussed above, the first, second, and third parameters are chosen from design parameters of at least diameter (D), edge thickness (ET), center thickness (CT), and applied load (F). In one embodiment, the first parameter is selected to be ET, the second parameter is selected to be D, and the third parameter is selected to be CT. In alternative embodiments, these or other design parameters may be utilized in Equation (1). The determination of which design parameter is the first parameter, second parameter, and third parameter, which are associated with k₁ and k₂, k₃ and k₄, and k₅ and k₆ in Equation (1), respectively, may be determined according to a curve fitting operation. The selected parameters are each fit to the experimental data using a modified form of Equation (2), where each parameter is substituted in place of ET in Equation (2) and fit to the experimental data. The accuracy of the fit is then judged and the design parameter which provides the most accurate fit is utilized as the first parameter. In one embodiment, the accuracy of the fit may be determined by minimization of the R² parameter of the fit. In alternative embodiments, other methods generally understood by those of skill in the art may be utilized to determine the accuracy of the fit. The second parameter is similarly determined using a modified form of Equation (4), where ET may be substituted with the first parameter determined above and where each remaining parameter is substituted in place of D listed in Equation (4). The accuracy of the fit of the modified form of Equation (4) is evaluated and the remaining parameter which provides the best fit is selected as the second parameter. This selection process is continued on the remaining design parameters.

The illustrated method 300 continues at step 304 by selecting a target applied load value for the rigid center portion. The value may be selected on the basis of various criteria. For example, a particular material may have been previously identified as desirable based on other criteria, e.g., cost, availability, biocompatibility, modulus, etc. Preferably, the target applied load value is selected to be a value that is likely to provide advantageous on-eye flexure. For example, the target applied load value can be selected to be lower than that of an existing product.

The illustrated method 300 continues at step 306 by entering the target applied load value into the equation and determining a diameter value, an edge thickness value, and a center thickness value that satisfy the equation. Preferably, a computer is used to identify sets of diameter, edge thickness and center thickness values that satisfy the equation. However, other suitable ways of identifying the sets of diameter, edge thickness and center thickness values that satisfy the equation can be used.

The illustrated method 300 continues at step 310 by manufacturing a sample rigid center portion having dimensions that correspond to (or are approximately the same as) the diameter value, the edge thickness value and the center thickness value, e.g., to one of the sets of diameter, edge thickness and center thickness values satisfying the equation that have been identified by computer at step 306 as described above. The illustrated method 300 continues at step 312 by determining an applied load value which provides a selected flexural deformation for the sample rigid center portion manufactured at step 310. The determined applied load value may be estimated or measured. The applied load value of the sample rigid center portion may be determined in various ways, e.g., by submission to a third party testing facility to obtain a measured applied load value, by measuring a related property and using it to determine an estimated applied load value, and/or, preferably, by direct measurement of applied load in accordance with International Standard ISO 11984:1999(E) as discussed above. In the event that a hybrid lens is manufactured, the substantially flexible skirt portion may be carefully trimmed away from the substantially rigid center portion prior to direct measurement of flexural deformation. Alternatively, as-machined rigid center portions may be provided for testing without prior attachment to a skirt portion.

The illustrated method 300 continues at step 314 by comparing the applied load value determined at step 312 to the target applied load value selected at step 304. This comparison may be used for various purposes, e.g., to validate or adjust the equation. The method 300 may thus be used to identify design parameters suitable for making the hybrid contact lenses described herein. It will be understood by those skilled in the art that Equation (1) and the constants k₁-k₇ described are not universal, and that suitable adjustments may be made based on the comparison at step 314. It will also be understood that multiple iterations of the method 300 (or variants thereof) may be suitably practiced to identify suitable design parameters for making a hybrid contact lens having the desired characteristics.

The illustrated method 300 includes optional steps 316 and 320. There are various situations in which practice of one or both of steps 316 and 320 may be desirable. For example, in the event that the target applied load is not achieved (e.g., the determined applied load is different from the target applied load at step 314), the method 300 may continue at step 316 by obtaining at least one of a second diameter value, a second edge thickness value, and a second center thickness value that satisfy the equation, e.g., in a matter similar to step 306. As described above, it will be appreciated that step 306 and step 316 may be practiced substantially simultaneously by identifying two or more sets of diameter, edge thickness and center thickness values that satisfy the equation, e.g., by computational methods.

The method 300 may continue at step 320 by manufacturing a second sample rigid center portion having dimensions that correspond to at least one of the second diameter value, the second edge thickness value, and the second center thickness value, in a manner similar to step 310. Such manufacturing may take place substantially simultaneously with the manufacturing at step 310, e.g., multiple samples having varying diameter, edge thickness, and center thickness values may be manufactured in accordance with sets of diameter, edge thickness and center thickness values that satisfy the equation.

The method 300 illustrates the selection of a target value for a certain design parameter (applied load) and the determination of values for three remaining design parameters (diameter, edge thickness and center thickness). Those skilled in the art will appreciate that target values may be selected for any one or more of the design parameters, and that the equation may be then be used to determine values or sets of values for the remaining design parameters that satisfy the equation. For example, in an embodiment, the method 300 comprises selecting target values for two of the diameter value, the edge thickness value, and the center thickness value; and entering the target applied load value and the two of the diameter value, the edge thickness value, and the center thickness value into the equation and determining a value for a remaining design parameter that satisfies the equation.

In an embodiment, the substantially rigid center portion is selected to be a material having a desired oxygen permeability value, e.g., a Dk of at least about 30 barrers, preferably at least about 100 barrers. A target applied load is then entered into an equation such as Equation (1) in a manner similar to that described above for step 306, to thereby determine diameter, edge thickness, and center thickness values that satisfy the equation. The design parameters identified by the method 300 illustrated in FIG. 3 (or a variant thereof, as discussed above), which may include multiple iterations, may be used to design and make embodiments of hybrid contact lenses described herein.

### EXAMPLES

A series of center portions for hybrid contact lenses having varying design parameters are manufactured by the methods described above and evaluated as follows. Samples tested are in the as-machined condition (not after removal from a skirt portion) in order to determine the load required to achieve a selected flexural deformation in a lens possessing selected design parameters. Positive (+) and negative (−) dioptric power center portions are tested, having dioptric powers of 3±, 6±, 9±, and 0. The modulus of the material used to make the center portion is approximately 12,900 kgf/cm². Flexural deformation values are determined in accordance with International Standard ISO 11984:1999(E) by measuring the applied load to cause 10%, 20%, and 30% deformation.

In the course of these investigations, parameters which may be used to predict the applied load that results in a selected level of flexural resistance of the center portions of hybrid contact lenses have been unexpectedly discovered. These parameters include, but are not limited to, the center thickness and edge thickness, as well as the diameter of the center portion. As discussed below, Examples 1-3 present testing results for (−) dioptric power lenses, where the center thickness and edge thickness parameters are varied while maintaining a diameter parameter value of approximately 8.5 mm. Examples 4-6 below present testing results for (+) dioptric power lenses, where the edge thickness and diameter parameters are varied, while maintaining a center thickness parameter value of approximately 0.2 mm. In both cases, predicted values of applied load are obtained in accordance with Equation (1). The predicted applied loads are also compared with experimental measurements to verify the accuracy of the model.

### Examples 1-3

### (−) Dioptric Power Lenses

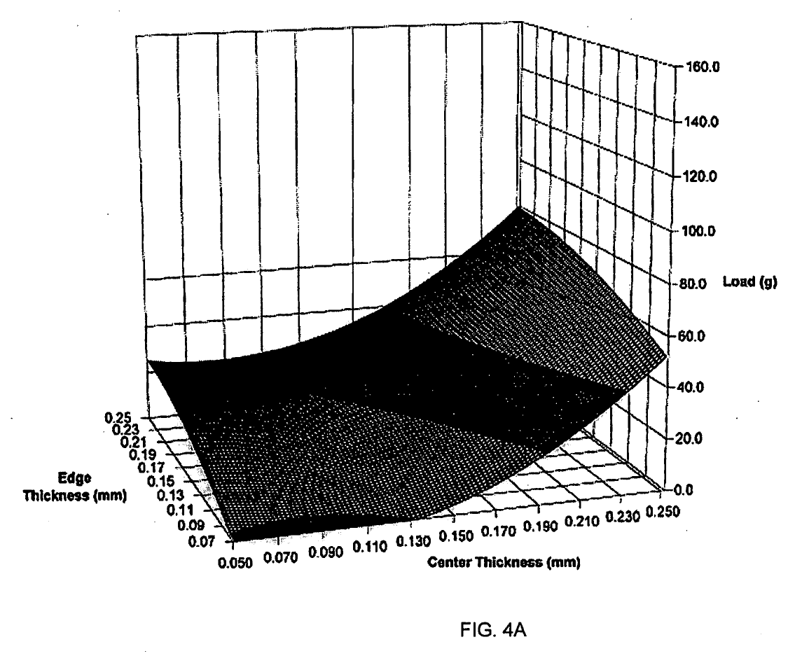

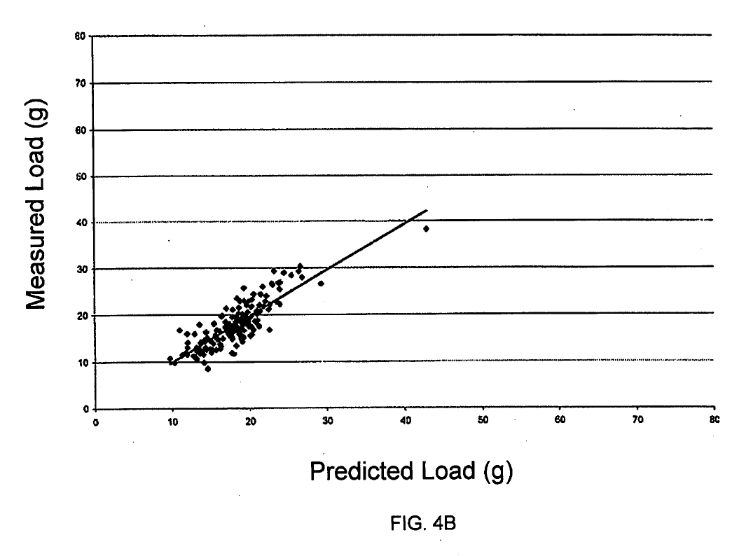

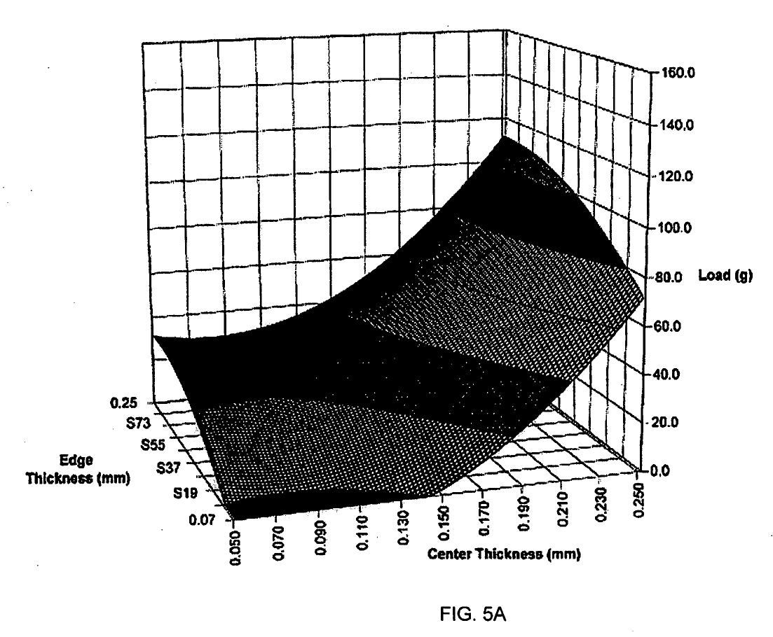

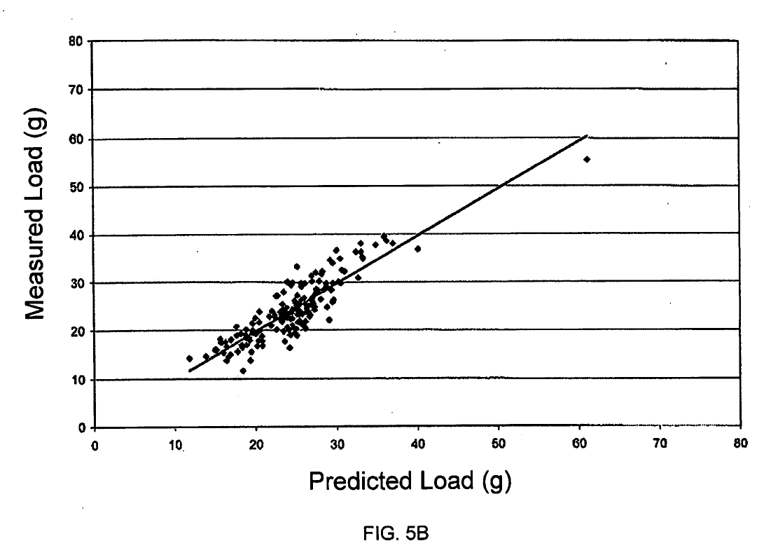

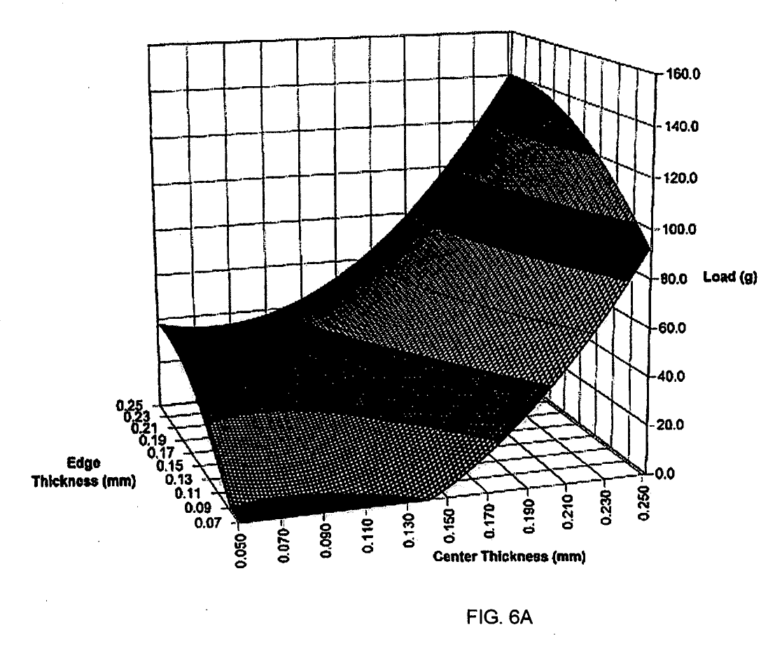

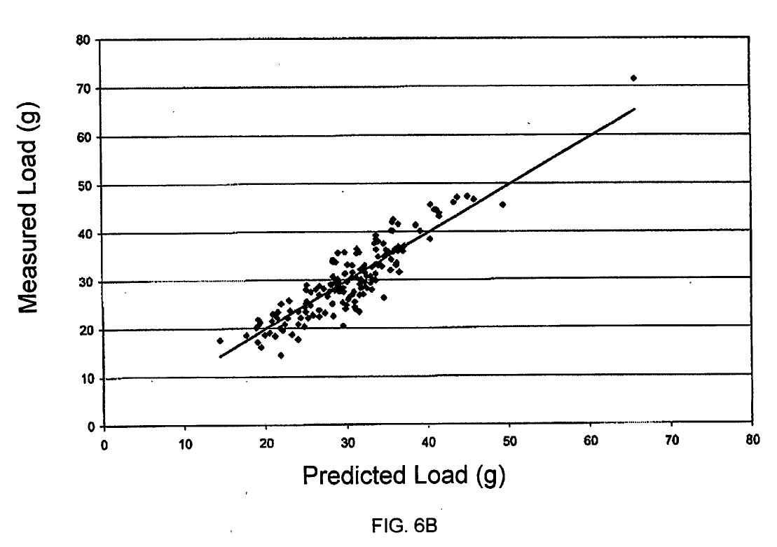

FIGS. 4A, 5A, and 6A present three-dimensional contour plots of the predicted applied loads, calculated according to Equation (1), that result in flexural deformations of approximately 10%, 20%, and 30% as a function of the edge and center thicknesses for a center portion of a (−) dioptric power hybrid lens. The approximate magnitude of the constants k₁-k₇ utilized in Equation (1) were determined as discussed above and are presented in Table 2 below.

TABLE 2
Equation (1) constants for (−) dioptric power center portions

| Ex- | % | | | | | | | |
|---|---|---|---|---|---|---|---|---|
| ample | Deformation | k₁ | k₂ | k₃ | k₄ | k₅ | k₆ | k₇ |
| 1 | 10 | 639 | 357 | 0.85 | 14.7 | 2072 | 348 | 51.5 |
| 2 | 20 | 1277 | 628 | 1.31 | 22.1 | 2926 | 476 | 63.5 |
| 3 | 30 | 1581 | 774 | 1.5 | 25.5 | 3624 | 572 | 69.4 |

FIGS. 4A, 5B, and 6B illustrate that Equation (1) provides a generally smooth, continuous three-dimensional surface. In general, as the peak deformation is increased, the predicted applied load values also increase. To utilize this surface, the center and edge thickness parameter values are selected and their position within the X-Y plane is determined. The load corresponding to those parameters is then ascertained by the intersection between the surface and the Z-axis at the X-Y position selected. For example, as illustrated in FIG. 4A, for center and edge thickness values of approximately 0.25, respectively, Equation (1) predicts an applied load of approximately 80 g.

The accuracy of the predictions provided by Equation (1) in the (−) dioptric power center portions may be evaluated by comparing the predicted and measured load values for the lenses, as illustrated in the correlation plots of FIGS. 4B, 5B, and 6B, where the measured and predicted load values are plotted against one another. Additionally, a line having a slope of approximately 1, extending through the origin, is also plotted in each figure. In interpreting the plot, the closer the data are to the line, the closer the measured and predicted applied load values. As illustrated in FIGS. 4B, 5B, and 6B, the data are clustered about the line, with substantially all of the predicted loads within approximately 25% of the measured value. Further, a significant fraction of the predicted applied loads deviate less than approximately 25% from the measured applied loads. These results indicate the model provides good predictive capability of the measured applied load in (−) dioptric power lenses.

### Examples 4-6

### (+) Dioptric Power Lenses

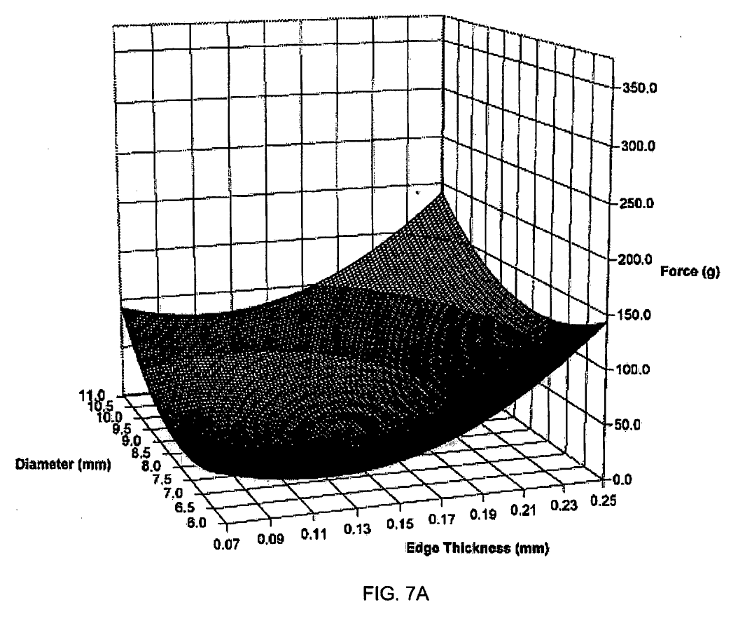

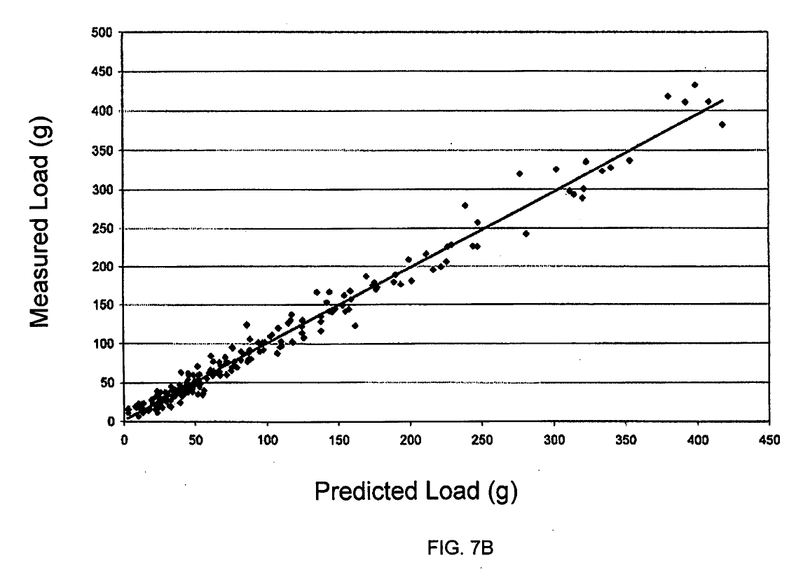

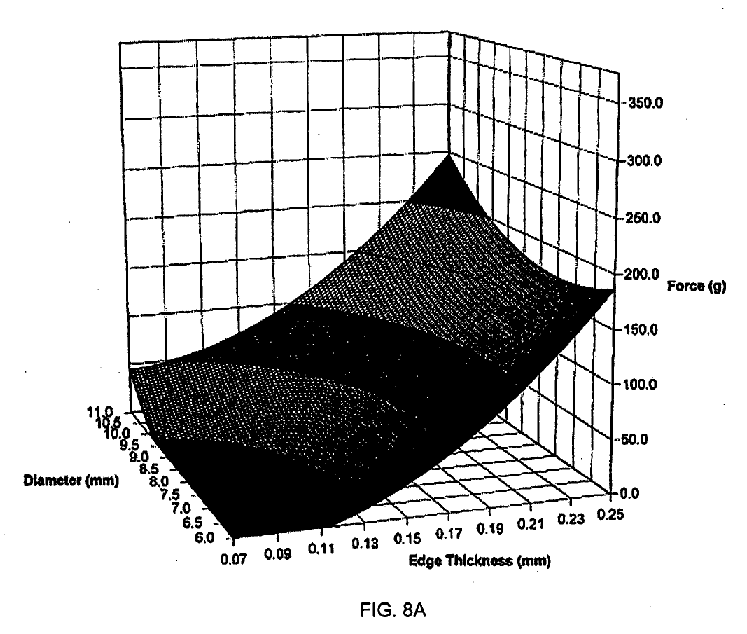

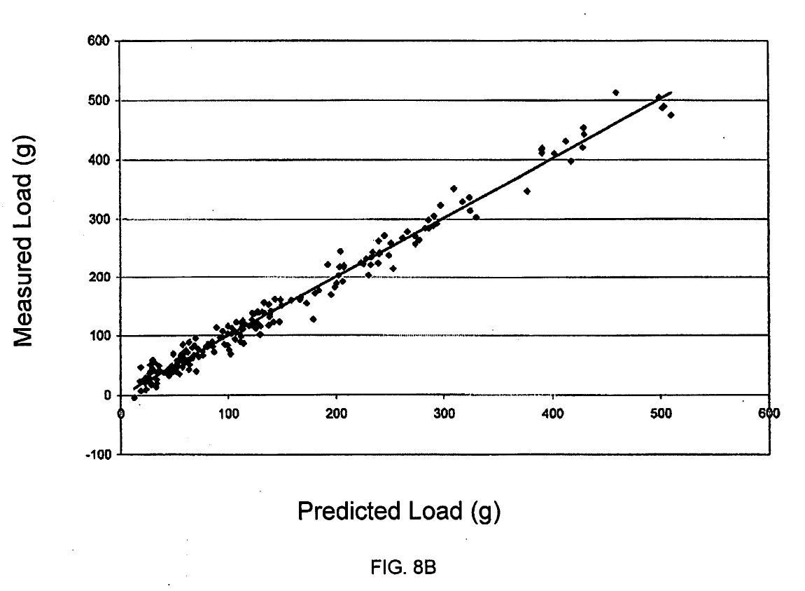

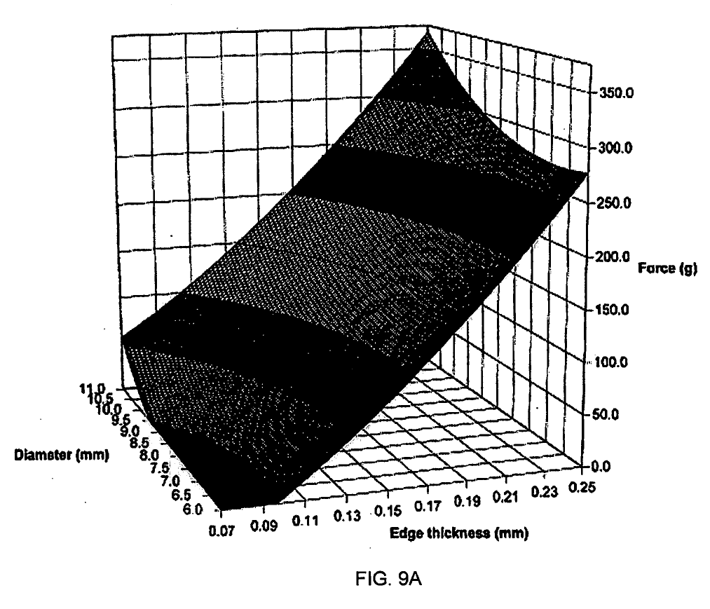

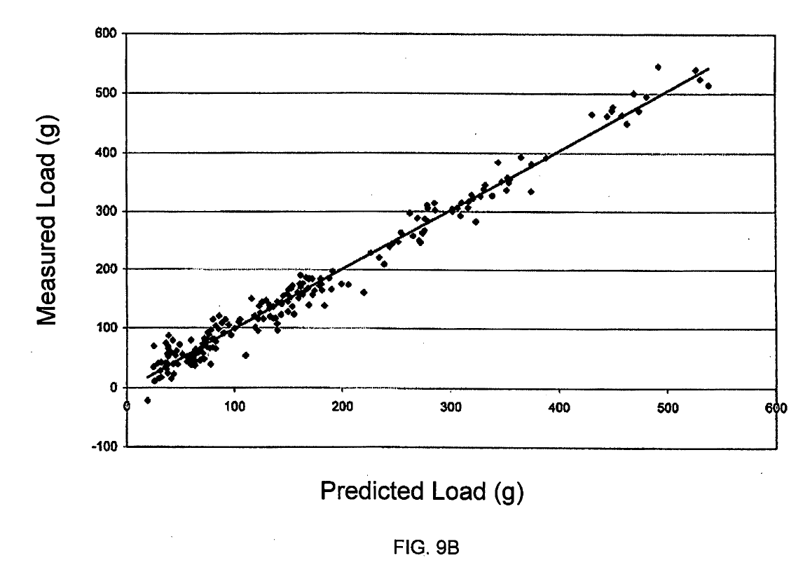

The process described in Examples 1-3 is repeated in Examples 4-6, except that the lenses tested are (+) dioptric power lenses. FIGS. 7A, 8A, and 9A present three-dimensional contour plots of the estimated applied load, calculated according to Equation (1), resulting in flexural deformations of 10%, 20%, and 30% as a function of the diameter and edge thickness for a center portion of a (+) dioptric power hybrid lens. The approximate magnitude of the constants k₁-k₇ utilized in Equation (1) were determined as discussed above and are presented in Table 3 below.

TABLE 3
Equation (1) constants for (+) dioptric power center portions

| | % | | | | | | | |
|---|---|---|---|---|---|---|---|---|
| Example | Deformation | k₁ | k₂ | k₃ | k₄ | k₅ | k₆ | k₇ |
| 4 | 10 | 6394 | 1502 | 7.5 | 118 | 605 | 352 | 510 |
| 5 | 20 | 5456 | 619 | 6.1 | 91 | 33 | 65.6 | 314 |
| 6 | 30 | 2946 | 787 | 5.4 | 73 | 709 | 312 | 112 |

Similar to FIGS. 4A, 5A, and 6A of Examples 1-3, FIGS. 7A, 8A, and 9A illustrate that Equation (1) provides a generally smooth, continuous three-dimensional surface. Likewise, as the peak deformation is increased, the predicted applied load values also increase.

The accuracy of the predictions provided by Equation (1) in the (+) dioptric power center portions may be evaluated by comparing the predicted and measured load values for the lenses, as illustrated in the correlation plots of FIGS. 7B, 8B, and 9B, where the measured and predicted load values are again plotted against one another and compared to a line having a slope of approximately 1, extending through the origin. As illustrated in FIGS. 7B, 8B, and 9B, the data are clustered about the line, with substantially all of the predicted loads within approximately 25% of the measured value. Further, a significant fraction of the predicted applied loads deviate less than approximately 25% from the measured applied loads. These results indicate the model provides good predictive capability of the measured applied load in (+) dioptric power lenses.

The foregoing description is that of certain features, aspects and advantages of the present invention to which various changes and modifications can be made without departing from the spirit and scope of the present invention. Moreover, the hybrid contact lens may not feature all objects and advantages discussed above to use certain features, aspects and advantages of the present invention. Thus, for example, those skilled in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or sub-combinations of these specific features and aspects of embodiments may be made and still fall within the scope of the invention. Accordingly, it should be understood that various features and aspects of the disclosed embodiments can be combined with or substituted for one another in order to form varying modes of the discussed hybrid contact lens.

What is claimed is:

1. A hybrid contact lens, comprising:
a substantially rigid center portion having a flexural deformation of about 10% at an applied load of at least about 50 grams and having a Dk of at least about 30 barrer; and
a substantially flexible skirt portion connected to the center portion.

2. The hybrid contact lens of claim 1, wherein the substantially rigid center portion has a Dk of at least about 100 barrer.

3. The hybrid contact lens of claim 1, wherein the flexural deformation is about 10% at an applied load in the range of about 50 grams to about 200 grams.

4. The hybrid contact lens of claim 1, wherein the flexural deformation is about 20% at an applied load of at least about 50 grams.

5. The hybrid contact lens of claim 1, wherein the flexural deformation is about 20% at an applied load in the range of about 50 to about 200 grams.

6. The hybrid contact lens of claim 1 wherein the flexural deformation is about 30% at an applied load of at least about 50 grams.

7. The hybrid contact lens of claim 1, wherein the flexural deformation is about 30% at an applied load in the range of about 50 to 200 grams.

8. The hybrid contact lens of claim 1, wherein the substantially rigid center portion has a thickness in the range of about 0.06 mm to about 0.40 mm.

9. The hybrid contact lens of claim 1, wherein the substantially rigid center portion has a diameter in the range of about 4.0 mm to about 12.0 mm.

10. The hybrid contact lens of claim 1, wherein the skirt portion comprises a substantially flexible annular portion coupled to the substantially rigid center portion at a junction defined at least in part by an outer edge of the substantially rigid center portion.

11. The hybrid contact lens of claim 10, wherein the skirt portion has an outer diameter in the range of about 10 mm to about 20 mm.

12. The hybrid contact lens of claim 1, wherein the substantially rigid center portion comprises a polymeric material that comprises one or more recurring units selected from linear alkyl (meth)acrylates, branched alkyl (meth)acrylates, cyclic (meth)acrylates, silicone-containing (meth)acrylates, fluorine-containing (meth)acrylates, hydroxyl group containing (meth)acrylates, (meth)acrylic acid, N-(meth)acryloylpyrrolidone, (meth)acrylamides, aminoalkyl (meth)acrylates, alkoxy group-containing (meth)acrylates, aromatic group containing (meth)acrylates, silicone-containing styrene derivatives, fluorine-containing styrene derivatives, styrene derivatives, and vinyl monomers.

13. The hybrid contact lens of claim 1, wherein the substantially flexible skirt portion comprises a polymeric material that comprises one or more recurring units selected from linear (siloxanyl)alkyl (meth)acrylates, branched (siloxanyl)alkyl (meth)acrylates, cyclic (siloxanyl)alkyl (meth)acrylates, silicone-containing (meth)acrylates, fluorine-containing (meth)acrylates, hydroxyl group containing (meth)acrylates, (meth)acrylic acid, N-(meth)acryloylpyrrolidone, (meth)acrylamides, aminoalkyl (meth)acrylates, alkoxy group-containing (meth)acrylates, aromatic group containing (meth)acrylates, glycidyl (meth)acrylate, tetrahydrofurfuryl (meth)acrylate, silicone-containing styrene derivatives, fluorine-containing styrene derivatives, styrene derivatives, and vinyl monomers.

14. A method of designing a hybrid contact lens having a substantially rigid center portion and a substantially flexible skirt portion, comprising:
providing an equation relating a plurality of design parameters for the rigid center portion, the plurality of design parameters comprising at least a diameter parameter, an edge thickness parameter, a center thickness parameter, and an applied load parameter;
selecting a target applied load value for the rigid center portion;
entering the target applied load value into the equation and determining a diameter value, an edge thickness value, and a center thickness value that satisfy the equation;
manufacturing a sample rigid center portion having dimensions that correspond to the diameter value, the edge thickness value and the center thickness value;
determining an applied load value for the sample rigid center portion; and
comparing the determined applied load value to the target applied load value.

15. The method of claim 14, further comprising:
obtaining at least one of a second diameter value, a second edge thickness value, and a second center thickness value that satisfy the equation; and
manufacturing a second sample rigid center portion having dimensions that correspond to said at least one of the second diameter value, the second edge thickness value, and the second center thickness value.

16. The method of claim 14, further comprising
selecting target values for two of the diameter value, the edge thickness value, and the center thickness value; and
entering the target applied load value and said two of the diameter value, the edge thickness value, and the center thickness value into the equation and determining a value for a remaining design parameter that satisfies the equation.

17. The method of claim 14, wherein the substantially rigid center portion has a Dk of at least about 30 barrer.

18. The method of claim 14, wherein the substantially rigid center portion has a Dk of at least about 100 barrer.

19. The method of claim 14, wherein the equation is given by Formula (1):
Applied load=k₁*(Edge Thickness)̂2−k₂*(Edge Thickness)+
k₃*(Diameter)̂2−k₄*(Diameter)+k₅*(Center Thickness)̂2+k₆*(Center Thickness)+
k₇.
wherein k₁-k₇ are constants.

20. The method of claim 18, wherein:
k₁ is in the range of about 600 to about 6400;
k₂ is in the range of about 300 to about 1600;
k₃ is in the range of about 0.8 to about 8;
k₄ is in the range of about 14 to about 120;
k₅ is in the range of about 30 to about 3700;
k₆ is in the range of about 60 to about 600 and;
k₇ is in the range of about 50 to about 600.
